(19) United States
(12) Patent Application Publication
(10) Pub. No.: US 2016/0009219 A1
(43) Pub. Date: Jan. 14, 2016

(54) BABY STROLLER LIGHTING SYSTEM

(71) Applicant: Sean Gilbert, Roseville, CA (US)

(72) Inventor: Sean Gilbert, Roseville, CA (US)

(21) Appl. No.: 14/793,681

(22) Filed: Jul. 7, 2015

Related U.S. Application Data
(60) Provisional application No. 61/999,056, filed on Jul. 14, 2014.

(51) Int. Cl. B60Q 1/26; F21V 23/04; F21S 4/00; F21S 9/03; B62B 9/00; B60Q 1/00

(52) U.S. Cl. CPC B60Q 1/2615; B62B 9/005; B60Q 1/0076; F21S 4/008; F21S 9/032; F21V 23/0407; F21V 23/0435; F21Y 2101/02

(57) ABSTRACT

A stroller lighting system is provided, comprising a light strip fastenable to the underside of a stroller; a power supply fastenable to a handle of the stroller; a wiring harness, fastenable to a frame of the stroller and configured to electrically connect the light strip to the power supply; and a switch electrically connected between the wiring harness and the power supply to activate and deactivate the light strip whereby, when the light strip is activated, ground beneath the stroller is illuminated. A baby stroller is also provided in which such a lighting system is integrated.

### RELATED APPLICATION DATA

The present application is related to and claims the benefit of commonly-owned and co-pending U.S. Provisional Application Ser. No. 61/999,056 filed on Jul. 11, 2014, and entitled BABY STROLLER LIGHTING SYSTEM, which application is incorporated herein by reference in its entirety.

### TECHNICAL FIELD

The present invention relates generally to baby strollers, carriages, and like carriers and, in particular, to lighting systems adapted for use with such carriers.

### BACKGROUND ART

Baby strollers, carriages, and other carriers have been used for many decades to transport babies safely around the outside world and much development has gone into making them safe. For example, strollers are typically designed to be lightweight and collapsible with safety mechanisms in place to prevent the stroller from collapsing while a baby is a passenger. Materials and parts are selected to eliminate choking and other dangers. Typically, baby strollers have a canopy or other form of shade for protection from the sun and bright lights, seat belts to keep the baby from falling out, and no moving parts within a baby's reach so that tiny fingers and toes don't get injured. Shock absorbers are now standard in many model strollers to absorb much of the impact of going up and down stairs, on and off curbs, and over uneven terrain or cracks in pavement or concrete.

While a baby stroller may be used most often during the daytime, there are instances when a parent takes the baby out at night or during periods of daylight hours when there is a lot of glare, for example in the late afternoon when the sun is setting. In these lower-visibility times, there is a risk that a motorist or bicyclist may not see the baby stroller. For example, when a baby stroller is made with materials that are dark in color, it may not be easily seen by someone driving a car during periods of low visibility, especially if there is glare in the driver's eyes. A pedestrian may have a chance to jump out of the way of a car whose driver doesn't see the pedestrian; however, a parent pushing a baby in a stroller may not. The weight and size of the stroller, in combination with the added weight of the baby and items that often accompany a baby stroller, such as a diaper bag and water bottles, make the baby and stroller a cumbersome, slow-moving vehicle in pedestrian and street traffic. While baby strollers are normally used on sidewalks rather than streets, crossing a street, even in a well-marked crosswalk and easily seen traffic signals, places the baby and parent at risk.

### SUMMARY OF THE INVENTION

The present invention provides a stroller lighting system, comprising a light strip fastenable to the underside of a stroller; a power supply fastenable to a handle of the stroller; a wiring harness, fastenable to a frame of the stroller and configured to electrically connect the light strip to the power supply; and a switch electrically connected between the wiring harness and the power supply to activate and deactivate the light strip whereby, when the light strip is activated, ground beneath the stroller is illuminated.

The present invention also provides a baby stroller, comprising: a frame; a set of wheels attached to the frame; a baby compartment attached to the frame; a handle attached to the frame; a light strip fastenable to the underside of the stroller; a power supply fastenable to the handle of the stroller; a wiring harness, fastenable to the frame of the stroller and configured to electrically connect the light strip to the power supply; and a switch electrically connected between the wiring harness and the power supply to activate and deactivate the light strip whereby, when the light strip is activated, ground beneath the stroller is illuminated.

### BRIEF DESCRIPTION OF THE DRAWINGS

FIG. 1 is a block diagram of an embodiment of the stroller lighting system of the present invention;

FIG. 2 is a view of the underside of a stroller to which the lighting system of FIG. 1 has been fastened;

FIG. 3 is a view of a portion of the frame of the stroller of FIG. 2; and

FIG. 4 is a perspective view of the stroller of FIG. 1 with the lighting system turned on.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

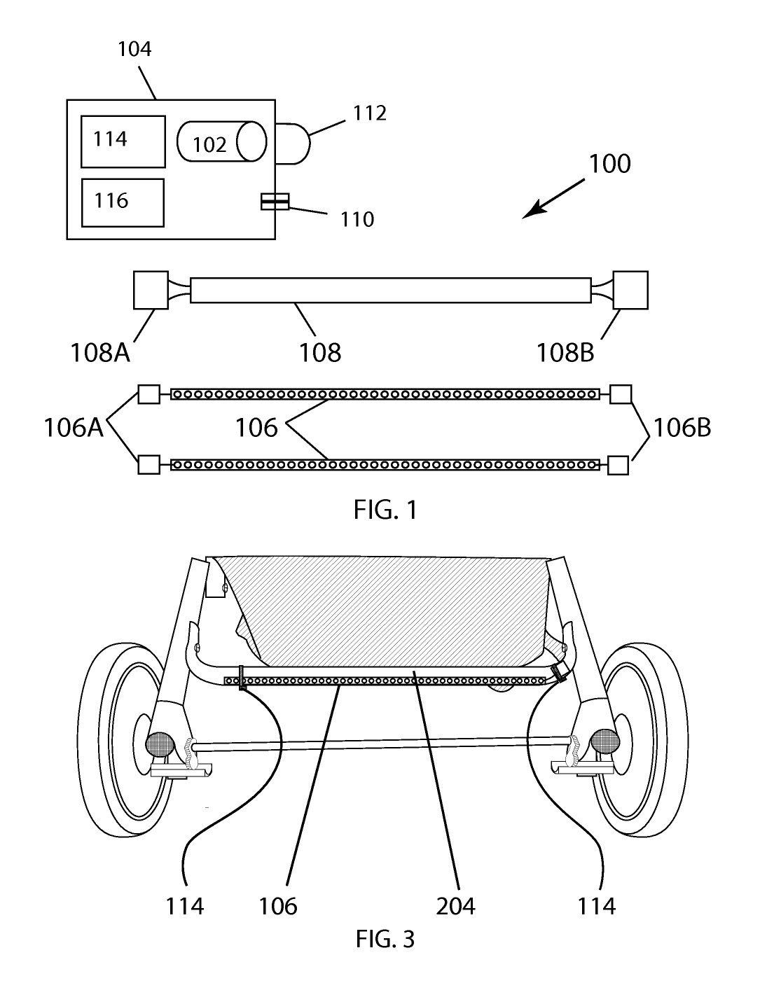

FIG. 1 is a block diagram of an embodiment of the stroller lighting system 100 of the present invention. The system 100 includes a power supply 102 enclosed in a protective housing 104. The system 100 further includes one or more light strips 106, such as light emitting diode (LED) strips or electroluminescence (EL) tape. The light strips 106 are electrically connected to one or more wiring harnesses 108 (one of which is shown in FIG. 1). Connectors 106A, 106B on the light stripe 106 may be coupled with corresponding connectors 108A, 108B on the wiring harness 108. The wiring harness 108 is connected to the power supply 102 through one or more connectors 110 mounted on the housing 104. A switch 112, also mounted on the housing 104, completes the circuit to electrically connect the light strips 106 to the power supply 102 and permit a user to turn the light strips 106 on and off. The light strips 106, the wiring harnesses 108, and the power supply 102 may also be electrically connected using pig-tail connectors.

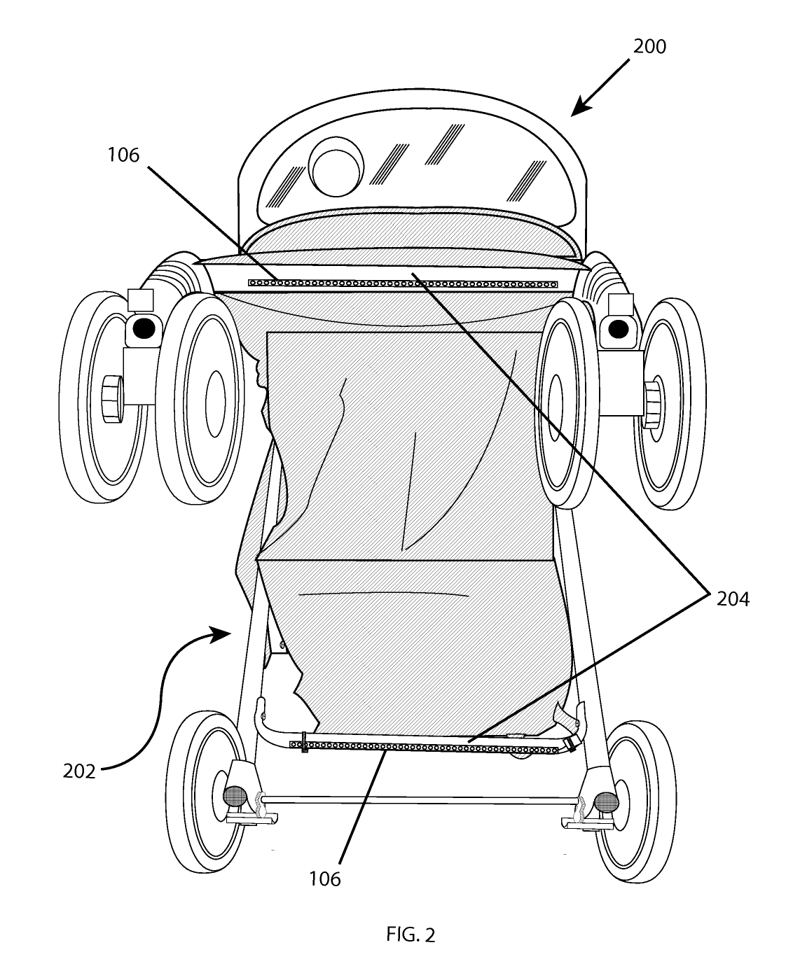

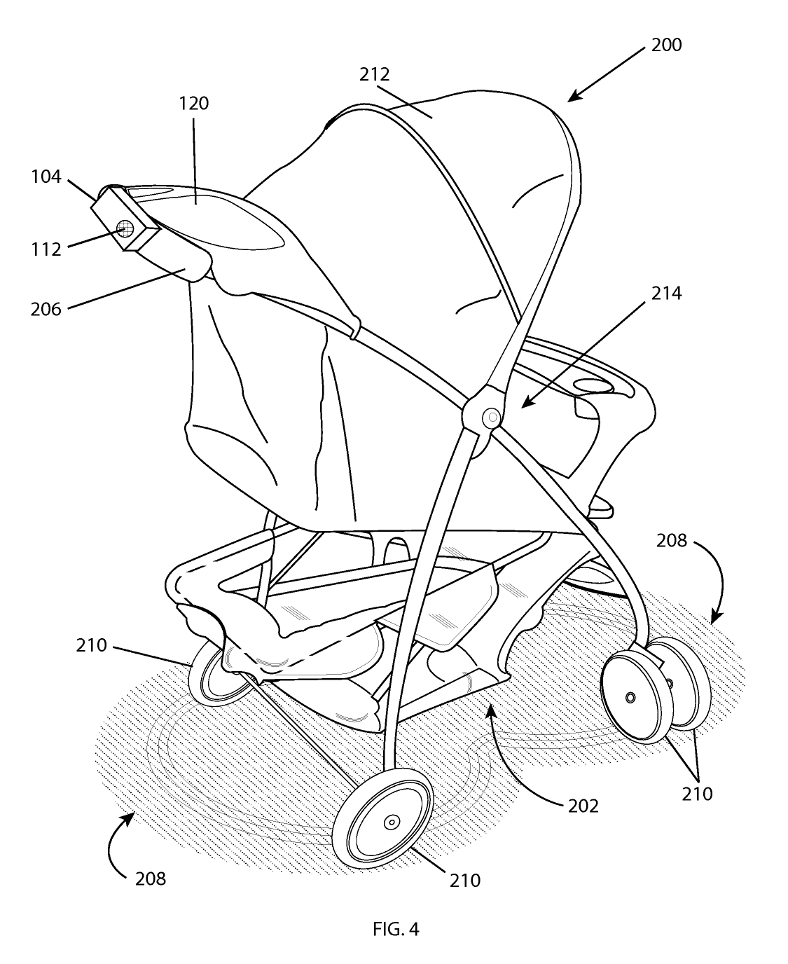

Turning to FIG. 2, the light strips 106 may be fastened to a stroller 200 to any appropriate part of the underside 202 of the stroller 200, such as the axles or the horizontal braces at the front and rear of the frame 204, to project light downward. The light strips 106 may be fastened to the stroller with any appropriate fastener, such as zip ties 114 (FIG. 3), double-sided tape, clamps, hook-and-loop material, among others, or a combination of fasteners for additional security. Alternatively, or in addition, light strips 106 may be fastened to or around the sides, front, and rear of the stroller 200 and project the light outward. In other embodiments, light strips 106 may be embedded in the stroller 200 material during manufacture.

The wiring harnesses 108 may be fastened along the frame 204 of the stroller 200 in a fashion similar to the way the light strips 106 are fastened. The housing 104 may be secured in any appropriate manner to the handle 206 of stroller 200 where the switch 112 will be in a convenient location for the user to operate (FIG. 4).

When the switch 112 is turned on, the light strips 106 are powered on and illuminate 208 the ground underneath and around the stroller 200 and around the wheels 210, as illustrated in FIG. 4.

The lighting system 100 may be provided with additional features. For example, a controller 116 in the housing 104 may allow the user to select different lighting modes, such as continuous, flashing, or sequential. The light strips 106 may include two or more different colored lights (or the LEDs may be able to emit different colored light) and the controller 116 may allow the user to selectively change the color and mode of the light, such as continuous, flashing, alternating colors, and sequential colors, among various possible modes. One of more additional light strips 106 may be fastened around the canopy 212 to softly illuminate the baby in the baby compartment 214 or to provide the baby with entertaining or pacifying lighting effects, activated by the user using the controller 116.

The power supply 102 may be a replaceable or rechargeable battery, such as a single 9 volt battery or a battery pack with multiple 1.5 volt batteries. If the battery or battery pack is rechargeable, it may be recharged by plugging a conventional wall charger into the housing 104 at home. Alternatively, or to supplement a wall charger, the battery or battery pack may be recharged using one or more solar panels 120 mounted on top of the stroller 200 (FIG. 4). A small generator mechanically connected to a wheel 210 may also, or instead, be used to charge the battery or battery pack. An LED mounted in the housing 104 may provide an indication of the charge state of the power supply 102.

The lighting system 100 may also include a light strip 106 fastened to or near the handle 206 in a location visible to the user. A device in the controller 104, such as a Bluetooth® receiver, may pair with a cellphone and activate the light strip 106 in a flashing mode when an incoming call is detected. In this way, the phone may placed in the silent mode so that incoming calls won't disturb the baby, but the user will be notified visually. Additionally, even with the phone ringer on, a user walking along a busy street may not be able to hear the ringing and the flashing light strip 106 will alert the user to incoming calls. An additional mode of the controller 104 may include a timing device, such as a timer, stopwatch, or alarm clock to provide a flashing light to indicate that a time programmed by the user has lapsed, such as a time to give the baby medicine or something to eat or drink.

The lighting system 100 may be sold as an after-market accessory, easily installed by the consumer. The lighting system 100 may also be integrated into the design of the stroller 200 and sold with the stroller 200 as a built-in feature.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A stroller lighting system, comprising:
a light strip fastenable to the underside of a stroller;
a power supply fastenable to a handle of the stroller;
a wiring harness, fastenable to a frame of the stroller and configured to electrically connect the light strip to the power supply; and
a switch electrically connected between the wiring harness and the power supply to activate and deactivate the light strip whereby, when the light strip is activated, ground beneath the stroller is illuminated.

2. The stroller lighting system of claim 1, further comprising a controller fastenable to the stroller and configured to select a mode of operation of the light strip from a plurality of modes comprising at least continuous, flashing, and sequential.

3. The stroller lighting system of claim 1, wherein the light strip comprises an electroluminescence strip.

4. The stroller lighting system of claim 1, wherein the light strip comprises a light emitting diode (LED) light strip.

5. The stroller lighting system of claim 4, wherein the LEDs in the light strip emit a plurality of colors.

6. The stroller lighting system of claim 5, further comprising a controller fastenable to the stroller and configured to control the colors emitted by the LEDs of the light strip.

7. The stroller lighting system of claim 5, further comprising a controller fastenable to the stroller and configured to select a mode of operation of the light strip from a plurality of modes comprising at least continuous, flashing, alternating colors, and sequential colors.

8. The stroller lighting system of claim 1, further comprising a Bluetooth® receiver fastenable to the stroller, electrically connected to the light strip and pairable to a mobile phone, the Bluetooth® receiver configured to activate the light strip in a flashing mode when an incoming call to the mobile phone is detected.

9. The stroller lighting system of claim 1, further comprising a timing device fastenable to the stroller, electrically connected to the light strip and configured to activate the light strip in a flashing mode when a predetermined amount of time has lapsed.

10. The stroller lighting system of claim 1, wherein the power supply comprises a rechargeable battery.

11. The stroller lighting system of claim 10, further comprising a solar panel fastenable to the stroller and electrically connected to recharge the rechargeable battery.

12. A baby stroller, comprising:
a frame;
a set of wheels attached to the frame;
a baby compartment attached to the frame;
a handle attached to the frame;
a light strip fastenable to the underside of the stroller;
a power supply fastenable to the handle of the stroller;
a wiring harness, fastenable to the frame of the stroller and configured to electrically connect the light strip to the power supply; and
a switch electrically connected between the wiring harness and the power supply to activate and deactivate the light strip whereby, when the light strip is activated, ground beneath the stroller is illuminated.

13. The stroller of claim 12, further comprising a controller fastenable to the stroller and configured to select a mode of operation of the light strip from a plurality of modes comprising at least continuous, flashing, and sequential.

14. The stroller of claim 12, wherein the light strip emits a plurality of colors and the stroller further comprises a controller fastenable to the stroller and configured to control the colors emitted the light strip.

15. The stroller of claim 14, wherein the controller is further configured to select a mode of operation of the light strip from a plurality of modes comprising at least continuous, flashing, alternating colors, and sequential colors.

16. The stroller of claim 12, further comprising a Bluetooth® receiver fastenable to the stroller, electrically connected to the light strip and pairable to a mobile phone, the Bluetooth® receiver configured to activate the light strip in a flashing mode when an incoming call to the mobile phone is detected.

17. The stroller of claim 12, further comprising a timing device fastenable to the stroller, electrically connected to the light strip and configured to activate the light strip in a flashing mode when a predetermined amount of time has lapsed.

18. The stroller of claim 12, wherein the power supply comprises a rechargeable battery.

19. The stroller of claim 18, further comprising a solar panel fastenable to the stroller and electrically connected to recharge the rechargeable battery.
